(19) United States
(12) Patent Application Publication
(10) Pub. No.: US 2024/0160918 A1
(43) Pub. Date: May 16, 2024

(54) LEARNING METHOD FOR ENHANCING ROBUSTNESS OF A NEURAL NETWORK

(71) Applicants: SK hynix Inc., Icheon (KR); Postech Academy-Industry Foundation, Pohang (KR)

(72) Inventors: Sein PARK, Daegu (KR); Eunhyeok PARK, Pohang (KR)

(21) Appl. No.: 18/189,489

(22) Filed: Mar. 24, 2023

(30) Foreign Application Priority Data
Nov. 7, 2022 (KR) 10-2022-0147423

(51) Int. Cl. G06N 3/08

(52) U.S. Cl. CPC G06N 3/08

(57) ABSTRACT

A learning method of a neural network system includes preparing a second neural network having the same weights as a first neural network which is pre-trained; adding noise to weights of the first neural network; generating a first output data of the first neural network and generating a second output data of the second neural network by providing input data to the first neural network and the second neural network; and calculating a loss function using the first output data, the second output data, and a true value corresponding to the input data.

### CROSS-REFERENCE TO RELATED APPLICATION

The present application claims priority under 35 U.S.C. § 119(a) to Korean Patent Application No. 10-2022-0147423, filed on Nov. 7, 2022, which is incorporated herein by reference in its entirety.

### BACKGROUND

### 1. Technical Field

Various embodiments generally relate to a learning method capable of improving robustness of a neural network against noise.

### 2. Related Art

When a neural network operates on an accelerator, errors between values generated by a learning model and those generated by the accelerator may occur irregularly due to Process, Voltage, and/or Temperature (PVT) variations occurring in components of the accelerator.

Due to the influence of such irregular errors, the accuracy of the neural network is lowered, resulting in poor stability of the neural network.

FIG. 1 illustrates a conventional neural network 1 and a learning method therefor.

A conventional neural network 1 includes a plurality of layers 11-1, 11-2, . . . , 11-n.

In the prior art disclosed in an article such as [symbol] Joshi, V., Le Gallo, M., Haefeli, S. et al. Accurate deep neural network inference using computational phase-change memory. Nat Commun 11, 2473 (2020). https://doi.org/10.1038/s41467-020-16108-9 [symbol] , additional learning is performed by adding random noise to the weights W₁, W₂, . . . , Wₙ corresponding to the plurality of layers, respectively.

Through this method, robustness of the neural network 1 can be enhanced to some extent, but not enough for practical applications.

### SUMMARY

In accordance with an embodiment of the present disclosure, a learning method of a neural network may include preparing a second neural network having the same weights as a first neural network which is pre-trained; adding noise to weights of the first neural network; generating a first output data of the first neural network and generating a second output data of the second neural network by providing input data to the first neural network and the second neural network; and calculating a loss function using the first output data, the second output data, and a true value corresponding to the input data.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a conventional neural network and a learning method therefor.

FIG. 2 illustrates a neural network system and a learning method therefor according to an embodiment of the present disclosure.

FIG. 3 is a graph showing an effect of an embodiment of the present disclosure.

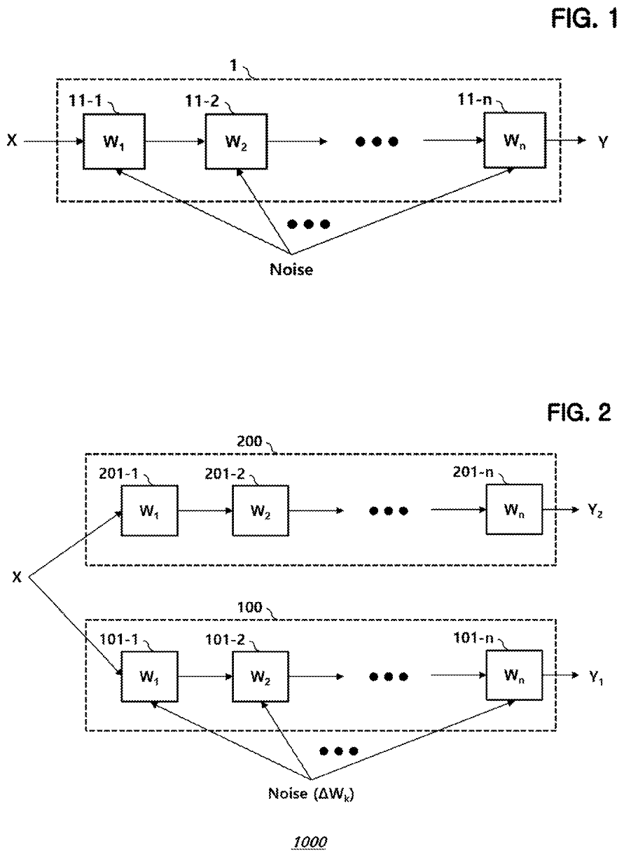

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

FIG. 2 illustrates a neural network system 1000 and a learning operation therefor according to an embodiment of the present disclosure.

The neural network system 1000 includes a first neural network 100 and a second neural network 200.

During an inference operation, only the first neural network 100 is used, and during a learning operation, both the first neural network 100 and the second neural network 200 are used.

In this embodiment, the neural network system 1000 including the first neural network 100 and the second neural network 200 are similar to but distinguishable from a system including a student neural network and a teacher neural network.

A teacher-student based neural network including a teacher neural network and a student neural network is well known by an article such as [symbol] Geoffrey Hinton, Oriol Vinyals, and Jeff Dean. Dark knowledge. Presented as the keynote in BayLearn, 2, 2014 [symbol] .

In general, in a teacher-student based neural network, a larger neural network with high accuracy is set as the teacher neural network, and a smaller neural network is set as the student neural network. In addition, the teacher neural network is in a state where learning has been completed and a learning operation is performed only for the student neural network. Accuracy is improved by allowing the student neural network to follow the output of the teacher neural network during the learning operation.

However, in an embodiment, the neural network system 1000 is

different from the conventional teacher-student based neural network in that the second neural network 200 is identical to the first neural network 100. That is, the first and second neural networks 100 and 200 have the same number of layers, the same number of neurons, and the same number of connections between the neurons and interconnecting the neurons in the same manner.

In addition, in an embodiment, the neural network system 1000 is different from the conventional teacher-student based neural network in that additional learning is performed for the first neural network 100 to improve stability even though the first neural network 100 has completed a prior learning operation.

The prior learning operation may be performed by a conventional technique, and a detailed description thereof will be omitted.

In an embodiment, additional learning operation corresponds to a fine-tuning operation for improving robustness of the neural network.

As described above, the second neural network 200 is the same as the first neural network 100. Therefore, prior learning operation has also been completed for the second neural network 200.

The second neural network 200 is used only for a learning operation for refining the weights and is not used in the inference operation.

The present embodiment is characterized in that an additional learning operation for the first and second neural networks 100 and 200 is performed by using the second neural network 200 which is the same as the first neural network 100. In the present embodiment, a type or a form of the first and second neural networks are not limited to a specific one.

For example, the first and second neural networks may be fully connected neural networks, convolutional neural networks, Long Short-Term Memory (LSTM) neural networks, and the like, but the type of the neural networks is not limited thereto.

Although FIG. 2 illustrates a neural network including a plurality of layers connected in series, the form of the neural networks is not limited thereto.

In this embodiment, the first neural network 100 includes a plurality of first layers 101-1, 101-2, . . . , 101-n, and the second neural network 200 includes a plurality of second layers 201-1, 202-2, . . . , 202-n, where n is a natural number greater than or equal to 1.

The plurality of first layers 101-1, 101-2, . . . , 101-n correspond to the plurality of second layers 201-1, 201-2, . . . , 201-n, respectively, and corresponding layers have the same weights.

For example, the first layer 101-1 and the second layer 201-1 have weights W₁, the first layer 101-2 and the second layer 201-2 have weights W₂, and the first layer 101-n and the second layer 201-n have weights Wₙ.

In this embodiment, the first neural network 100 and the second neural network 200 are additionally trained at the same time by an additional learning operation.

During the additional learning operation, noise is added to the weights of the plurality of first layers 101-1, 101-2, . . . , 101-n, but noise is not applied to the plurality of second layers 201-1, 201-2, . . . , 201-n.

For example, when a weight of the k^{th} second layer 201-k is set to Wₖ during the additional learning operation, a corresponding weight of the k^{th} first layer 101-k is set to Wₖ+ΔWₖ. In this case, k is a natural number greater than or equal to 1 and smaller than or equal to n.

In this case, ΔWₖ corresponds to an added noise component, and the noise component may be determined using a result of modeling noise that is generated in the accelerator. New values of the added noise component may be generated for time the additional learning operation is performed, such as by using a random or pseudo-random noise generator to generate the values of the added noise component.

For example, a noise component may be determined by a Gaussian distribution model, but the type of model should not be limited thereto. The noise may correspond to noise arising in internal operations of the first and second neural networks 100 and 200 when those operations are performed in by analog means, such as by summing currents or voltages, but embodiments are not limited thereto.

During the additional learning operation, input data X is provided to both the first neural network 100 and the second neural network 200, and as a result the first output data Y₁ is provided from the first neural network 100 and the second output data Y₂ is provided from the second neural network 200.

During the additional learning operation, the weights are adjusted so that the first output data Y₁ and the second output data Y₂ become identical.

To this end, in an embodiment, the loss function Loss is calculated as a combination of a first loss function Lₛ, a second loss function L_{dist}, and a third loss function Lₜ.

The first loss function Lₛ is a loss function of the first neural network 100, and represents a difference function between the first output data Y₁ output from the first neural network 100 for the input data X and a true value Y_{T} corresponding to the input data X.

The second loss function L_{dist} corresponds to a function for measuring similarity between the first output data Y₁ and the second output data Y₂.

The third loss function Lₜ is a loss function of the second neural network 200, and is represented as a difference function between the second output data Y₂ output from the second neural network 200 and the true value Y_{T}.

In an embodiment, a cross entropy function is used as the difference function. Since the cross entropy function is well known, detailed description thereof is omitted.

The loss function Loss used in this embodiment can be expressed as Equation 1.

Loss=αLs+(1−α)×L_{dist}+Lₜ [Equation 1]

In Equation 1, α is a balance parameter, and the balance parameter α is a value between 0 and 1 and adjusts a contribution ratio of the first loss function Lₛ and the second loss function L_{dist}. In this embodiment, 0.1 is used as the balance parameter α.

In this embodiment, the second loss function L_{dist} is expressed as Equation 2.

$${L}_{dist} = {T}^{2} \times {L}_{KLD} ( log ( softmax ( \frac{{Y}_{1}}{T} ) ) , log ( softmax ( \frac{{Y}_{2}}{T} ) ) ) \qquad [ Equation 2 ]$$

In this embodiment, the second loss function L_{dist} is determined using a Kullback-Leibler (KL)-divergence function L_{KLD}, which receives two distributions generated with log values of the SoftMax function for each of the first output data Y₁ and the second output data Y₂ as input.

In Equation 2, T represents a temperature coefficient. The temperature coefficient T serves to adjust characteristics of the distributions used in the second loss function L_{dist}. In this embodiment, 10 is used as the temperature coefficient.

Since the SoftMax function is a well-known function that generates a distribution from vector-type input data, and the KL-divergence function is a well-known function that measures similarity between two distributions, detailed descriptions thereof will be omitted.

Updating weights according to outputs of the above loss functions are obvious to those skilled in the art, so a detailed description thereof will be omitted.

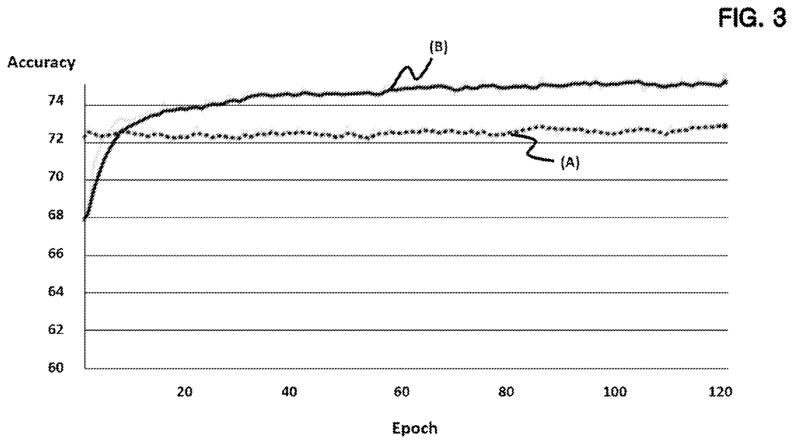

FIG. 3 is a graph showing effect of the present embodiment.

The graph in FIG. 3 represents change in accuracy according to the number of epochs during the additional learning operations. In FIG. 3, (A) corresponds to a conventional art where the first neural network 100 is trained in a conventional manner, and (B) corresponds to the present embodiment where the first neural network 100 is trained according to the present embodiment.

As shown in the graph, it can be seen that the accuracy is further improved in the present embodiment after a relatively small number of epochs have passed during the additional learning operation.

Although various embodiments have been illustrated and described, various changes and modifications may be made to the described embodiments without departing from the spirit and scope of the invention as defined by the following claims.

What is claimed is:

1. A learning method of a neural network, the learning method comprising:
preparing a second neural network having the same weights as a first neural network which is pre-trained;
adding noise to weights of the first neural network;
generating a first output data of the first neural network and generating a second output data of the second neural network by providing input data to the first neural network and the second neural network; and
calculating a loss function using the first output data, the second output data, and a true value corresponding to the input data.

2. The learning method of claim 1, wherein calculating the loss function comprises:
calculating a first loss function using the first output data and the true value;
calculating a second loss function using the first output data and the second output data;
calculating a third loss function using the second output data and the true value; and
combining the first loss function, the second loss function, and the third loss function.

3. The learning method of claim 2, wherein the first loss function corresponds to a cross-entropy between the first output data and the true value, and third loss function corresponds to a cross-entropy between the second output data and the true value.

4. The learning method of claim 2, wherein the second loss function corresponds to a Kullback-Leibler divergence function receiving a distribution generated from the first output data and a distribution generated from the second output data.

5. The learning method of claim 2, wherein the second loss function is determined according to the equation:
$${L}_{dist} = {T}^{2} \times {L}_{KLD} ( log ( softmax ( \frac{{Y}_{1}}{T} ) ) , log ( softmax ( \frac{{Y}_{2}}{T} ) ) )$$
wherein L_{dist} is the second loss function, Y₁ is the first output data, Y₂ is the second output data, L_{KLD} is the Kullback-Leibler divergence function, and T is a temperature coefficient used to adjust the characteristics of the distributions used in the second loss function L_{dist}.

6. The learning method of claim 2, wherein the first loss function, the second loss function, and the third loss function are linearly combined, and wherein a sum of a coefficient applied to the first loss function and a coefficient applied to the second loss function is equal to 1.

7. The learning method of claim 1, wherein the first neural network is identical to the second neural network.
